(19) United States
(12) Patent Application Publication
(10) Pub. No.: US 2004/0107424 A1
(43) Pub. Date: Jun. 3, 2004

(54) INITIALIZATION PROCESS IN A DEVICE DRIVER

(76) Inventor: Chien-Fa Wang, Taipei Hsien (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/249,534

(22) Filed: Apr. 17, 2003

(30) Foreign Application Priority Data
Dec. 3, 2002 (TW) 91135001

(51) Int. Cl. G06F 9/00; G06F 9/24

(52) U.S. Cl. 719/321; 713/1

(57) ABSTRACT

An initialization process in a device driver is provided. The device driver runs in a learning mode to read and store the initialization parameter that it needs. Then, the device driver runs in a release mode to initialize the hardware device with the initialization parameter previously stored. Therefore, the time for calibrating hardware device repeatedly is reduced significantly.

### CROSS REFERENCE TO RELATED APPLICATIONS

This application claims the priority benefit of Taiwan application serial no. 91135001, filed Dec. 3, 2002.

### BACKGROUND OF INVENTION

1. Field of Invention

The present invention generally relates to a device driver, and more particularly, to an initialization process in a device driver.

2. Description of Related Art

In the past, desktop, notebook and industrial computers were the general devices used for processing information in personal, office or factory. However, thanks to the requirements of miniaturization and easy utilization, different information appliances such as SetTopBox, WebPad, and Personal Digital Assistant (PDA) are now being developed and becoming more and more popular.

In the past, most of the desktop, notebook and industrial computers included a Basic Input/Output System (BIOS). Therefore, the initialization of such a hardware device, e.g. the standard Video Graphic Array (VGA) device was achieved by performing the BIOS operation. However, most of various miniature information appliances, e.g. SetTopBox, WebPad, and PDA do not have BIOS. Since most of such processor systems use a so-called Embedded Operating System (Embedded 0. S.), the initialization of its hardware device such as the standard VGA device is achieved by the device driver that drives the hardware device. The detailed workflow is shown in the device driver initialization process of FIG.1. After the device driver is loaded in step S110, the flow enters into step S120 to initialize the hardware device. Then, it enters into step S130 where the controlling is returned to the operating system.

Since the required initialization parameter has to be pre-calibrated when the hardware device is under design, when the same initialization parameter of a hardware device, e.g. standard VGA device, is used in various processor systems that have or do not have the BIOS with it, the device driver must be calibrated repeatedly in both the BIOS and the hardware device.

Since various parameters have to be tested repeatedly in the calibration, and the optimum initialization parameter is used based on the test results, the calibration becomes a great burden to the hardware device designer. Therefore, for those hardware devices with the BIOS having the previously calibrated initialization parameter, e.g. the standard VGA device, according to the initialization process shown in FIG. 1, repeatedly calibrating significantly wastes a great deal of time writing a device driver of the processor system that does not have BIOS.

### SUMMARY OF INVENTION

To solve the problem mentioned above, the present invention provides a device driver initialization process. The device driver runs in a learning mode to read and store the initialization parameter that it needs. Then, the device driver runs in a release mode to initialize the hardware device with the initialization parameter previously stored. Therefore, the time for calibrating the hardware device repeatedly is reduced significantly.

In order to achieve the object mentioned above and others, the present invention provides a device driver initialization process to initialize the hardware device of the processor system such as the SetTopBox, wherein the hardware device is such as a standard VGA device. The device driver initialization process comprises the steps as follows: first, the device driver runs in a learning mode to read and store the initialization parameter of the hardware device that has been initialized; then, the device driver runs in a release mode to initialize a hardware device that has not been initialized yet with the initialization parameter previously stored.

In the preferred embodiment of the present invention, the hardware device that has been initialized runs the BIOS of the processor system before the device driver runs in the learning mode, to initialize the hardware device with the initialization parameter that has been calibrated by the BIOS.

When the device driver runs in the learning mode, the initialization parameter is stored in the operating system registry of the processor system or stored in the processor system storage media such as the hard disk.

The present invention further provides a device driver initialization process to initialize the hardware device of the processor system such as the SetTopBox, wherein the hardware device is such as a standard VGA device. The device driver initialization process comprises the steps as follows: first, reading an initialization parameter needed by the hardware device, wherein the initialization parameter is obtained by reading and storing the hardware device that has been initialized; and initializing the hardware device with the initialization parameter mentioned above by the device driver.

In the preferred embodiment, the hardware device that has been initialized runs the BIOS of the processor system to initialize the hardware device with the initialization parameter that has been calibrated by the BIOS. Moreover, the reading and storing the parameter of the hardware device that has been initialized is achieved when the device driver is running in the learning mode.

Furthermore, when the device driver runs in the learning mode, the initialization parameter needed by the hardware device is stored in the operating system registry of the processor system or stored in the processor system storage media such as the hard disk.

From the description mentioned above, the present invention provides a device driver initialization process. The device driver runs in a learning mode to read and store the initialization parameter that it needs. Then, the device driver runs in a release mode to initialize the hardware device with the initialization parameter previously stored. Therefore, the time for calibrating the hardware device repeatedly is reduced significantly.

### BRIEF DESCRIPTION OF DRAWINGS

The accompanying drawings are included to provide a further understanding of the invention, and are incorporated in and constitute a part of this specification. The drawings illustrate embodiments of the invention, and together with the description, serve to explain the principles of the invention. In the drawings,

FIG. 1 schematically shows a flow chart of a conventional device driver initialization process;

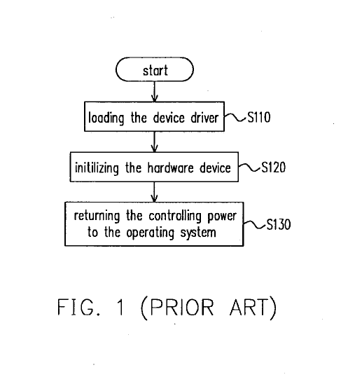

FIG. 2 schematically shows a flow chart of a device driver learning mode of a preferred embodiment according to the present invention;

FIG. 3 schematically shows a flow chart of a device driver release mode of a preferred embodiment according to the present invention; and

FIG. 4 schematically shows a flow chart of a device driver initialization process of a preferred embodiment according to the present invention.

### DETAILED DESCRIPTION

A device driver of the standard VGA device that is installed in the SetTopBox is exemplified hereinafter to explain the operating principle of the present invention. However, it will be apparent to one of the ordinary skill in the art that it can be applied to the device driver that is installed in the hardware device of various processor systems so as to significantly save the time spent for calibrating the hardware device repeatedly.

In order to maintain its display quality, the I/O parameters are stored through hundreds of the registers, e.g. SR0˜SR4, CR0˜CR24, GR0˜GR8, AR0˜AR20, 256 RAMDAC, and miscellaneous registers when designed in the standard VGA device, so as to calibrate the initialization parameters such as the horizontal frequency, vertical frequency, palette, active region, and overscan region that are related to the display. Most register set addressing processes use a so-called index addressing process, in other words, an index register is used to set an index value of the register that is to be accessed, and the data register is subsequently used to access the data of the register that is indicated by the index value.

The index register address of the SR0˜SR4 register set is I/O port 3C4H, and the data register address is I/O port 3C5H. Therefore, the following I/O instructions can be used to read data from SR3 register and save it into variable X:

OUT 3C4H, 3

IN X, 3C5H

Moreover, following I/O instructions can be used to write value of D into SR2 register:

OUT 3C4H, 2

OUT 3C5H, D

The accessing process of other registers is similar to the one used by the SR0˜SR4 register set. However, the I/O port addresses of the index register and data register have to be modified. For example, the I/O port addresses for the index register and data register of the CR0˜CR24 register set are 3D4H and 3D5H, respectively. The I/O port address for the index register and data register of the GR0˜GR8 register set is 3CEH and 3CFH, respectively. The I/O port addresses for the index register and data register of the AR0˜AR20 register set are 3C0H and 3C1H, respectively. The I/O port addresses for the index register and data register of the 256 RAMDAC registers are 3C7H, 3C8H, and 3C9H, respectively. Wherein, the reason for the 256 RAMDAC registers use 3 I/O port addresses is because its reading and writing uses 3C7H and 3C8H respectively, in other words, its reading and writing uses the I/O port address of different index register. Since the miscellaneous register is not group register, the index register is not used by it. However, its reading and writing data register uses 3CCH and 3C2H, two different I/O port addresses, respectively.

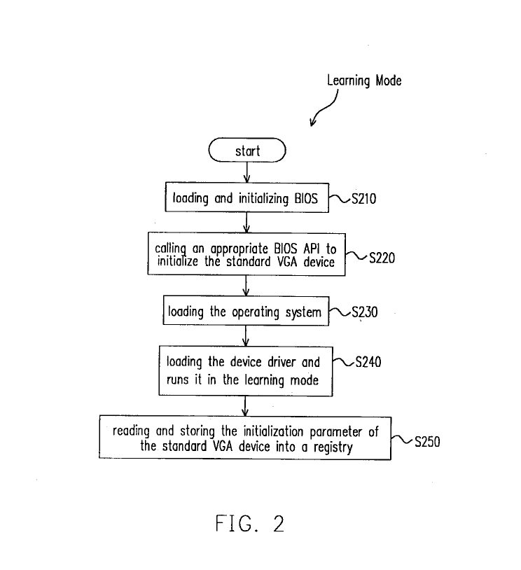

It is assumed we intend to initialize the standard VGA device of the SetTopBox that uses Embedded O.S. to graphic mode of 320×200 resolution and 256 display colors (i.e. Mode: 13). At first, the device driver runs in a learning mode to read and store the initialization parameters of the standard VGA device that has been initialized. The procedure flow is as shown in FIG. 2. When the system is power-on, the BIOS having the calibrated initialization parameter of the standard VGA device is loaded (S210). The appropriate BIOS API is called to initialize the standard VGA device (S220), wherein the initialization process can be achieved by using following instructions:

MOV AX, 13H

INT 10H

When an API call of the interrupt operation 1 OH is executed, the I/O instructions mentioned above are sued by BIOS to write values of hundreds of the registers, e.g. SR0˜SR4, CR0˜CR24, GR0˜GR8, AR0˜AR20, 256 RAMDAC, and miscellaneous registers, so as to initialize the standard VGA device to its MODE 13 optimum setting. Then, the Embedded O. S. is loaded (S230), and the device driver runs in the learning mode (S240), so that the device driver reads the initialization parameter of the standard VGA device and stores it into the registry (S250). Of course, it will be apparent to one of the ordinary skill in the art that the initialization parameter also can be stored in the storage media such as hard disk in this step for further process.

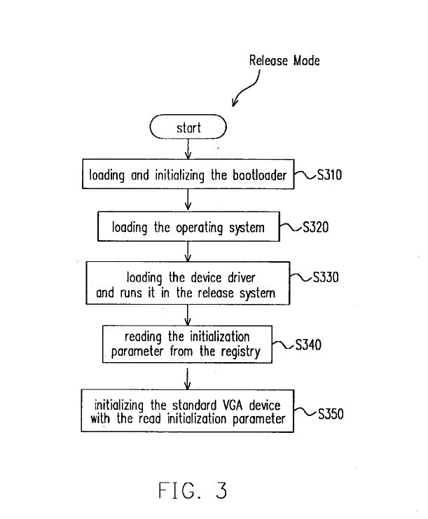

When the device driver runs in the learning mode, after the initialization parameter that has been calibrated in BIOS is stored, the stored initialization parameter can be used to initialize other standard VGA device. Its detail flows are shown in FIG. 3. When the system is power-on, the bootloader is loaded and initialized by the processor system (S310). Then, the Embedded O.S. is loaded (S320), and the device driver runs in a release mode (S330). Meanwhile, the device driver reads the stored initialization parameter from the registry or storage media according to the address of the stored initialization parameter (S340), so as to initialize the standard VGA device (S350). Therefore, since the device driver uses the initialization parameter that has been calibrated in BIOS to initialize the hardware device without having to repeatedly calibrate it, the time for calibrating the hardware device repeatedly is reduced significantly.

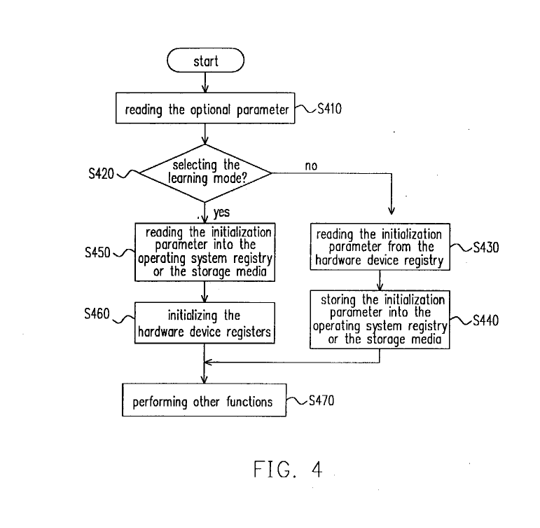

Referring to FIG. 4, it schematically shows a flow chart of a device driver initialization process of a preferred embodiment according to the present invention. When the device driver is running, at first, a parameter selected by the device driver is read in (S410), wherein the parameters in the standard VGA device of the example mentioned above comprises display mode setting parameter, the optional parameter for running in the learning mode so as to store the initialization parameter, or the optional parameter for running in the release mode so as to apply the stored initialization parameter.

If it is determined in step S420 that the learning mode is selected, the required calibrated initialization parameter is read from the register of standard VGA hardware device (S430). Then, the initialization parameter is stored in the operating system registry or the storage media such as the hard disk (S440), and subsequently perform other functions (S470).

If it is determined in step S420 that the learning mode is not selected, in other words, the release mode is selected, the initialization parameter stored by the learning mode is read from the operating system registry or storage media (S450), and this initialization parameter is used to initialize the hardware device, for example, the parameter is written into the register to initialize the hardware device (S460), and subsequently perform other functions (S470).

In summary, the present invention provides a device driver initialization process. The device driver according to the present invention runs in a learning mode to read and store the initialization parameter that it needs. Then, the device driver runs in a release mode to initialize the hardware device with the initialization parameter previously stored. Therefore, the time for calibrating hardware device repeatedly is reduced significantly.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

1. A device driver initialization process for initializing a hardware device of a processor system, comprising:
running the device driver in a learning mode, so as to read and store an initialization parameter of the hardware device that has been initialized; and
switching the device driver to a release mode, so as to initialize the hardware device with the initialization parameter.

2. The device driver initialization process of claim 1, further comprising:
before the device driver runs in the learning mode, a BIOS of the processor system is running first, so as to initialize the hardware device with the initialization parameter that has been calibrated by the BIOS.

3. The device driver initialization process of claim 1, wherein when the device driver runs in the learning mode, the initialization parameter is stored in a registry of an operating system of the processor system.

4. The device driver initialization process of claim 1, wherein when the device driver runs in the learning mode, the initialization parameter is stored in a storage media of the processor system.

5. The device driver initialization process of claim 4, wherein the storage media is a hard disk.

6. The device driver initialization process of claim 1, wherein the processor system is a SetTopBox.

7. The device driver initialization process of claim 1, wherein the hardware device is a standard VGA device.

8. A device driver initialization process for initializing a hardware device of a processor system, comprising:
reading an initialization parameter that is needed by the hardware device, wherein the initialization parameter is obtained by reading and storing the initialized parameter of the hardware device; and
initializing the hardware device by the device driver with the initialization parameter.

9. The device driver initialization process of claim 8, wherein the initializing parameter is achieved by the step of:
running a BIOS of the processor system so as to initialize the hardware device with the initialization parameter that has been calibrated by the BIOS.

10. The device driver initialization process of claim 8, wherein the reading and storing the initialized parameter of the hardware device is achieved by running the device driver in a learning mode.

11. The device driver initialization process of claim 10, wherein when the device driver runs in the learning mode, the initialization parameter needed by the hardware device is stored in a registry of an operating system of the processor system.

12. The device driver initialization process of claim 10, wherein when the device driver runs in the learning mode, the initialization parameter needed by the hardware device is stored in a storage media of the processor system.

13. The device driver initialization process of claim 8, wherein the processor system is a SetTopBox.

14. The device driver initialization process of claim 8, wherein the hardware device is a standard VGA device.

15. A device driver initialization parameter learning process for learning an initialization parameter of a hardware device of a processor system, comprising:
reading the initialization parameter that has been initialized and is stored in a hardware device register; and
storing the initialization parameter.

16. The device driver initialization parameter learning process of claim 15, wherein the initialization parameter is stored in a registry of an operating system of the processor system.

17. The device driver initialization parameter learning process of claim 15, wherein the initialization parameter is stored in a storage media of the processor system.

18. The device driver initialization parameter learning process of claim 17, wherein the storage media is a hard disk.

19. The device driver initialization parameter learning process of claim 15, wherein the processor system is a SetTopBox.

20. The device driver initialization parameter learning process of claim 15, wherein the hardware device is a standard VGA device.
